(19) United States
(12) Patent Application Publication
(10) Pub. No.: US 2024/0280396 A1
(43) Pub. Date: Aug. 22, 2024

(54) Level Detection System

(71) Applicant: Breville Pty Limited, Alexandria (AU)

(72) Inventors: Duncan Bruce HELLMERS, Alexandria (AU); Johnson THIE, Alexandria (AU); Stephen John MCCLEAN, Alexandria (AU)

(73) Assignee: Breville Pty Limited, Alexandria (AU)

(21) Appl. No.: 18/571,458

(22) PCT Filed: Jun. 24, 2022
(86) PCT No.: PCT/AU2022/050644

§ 371 Date: Dec. 18, 2023

(30) Foreign Application Priority Data
Jun. 24, 2021 (AU) 2021901909

(51) Int. Cl. G01F 23/263; A47J 31/44

(52) U.S. Cl. CPC G01F 23/266; G01F 23/268; A47J 31/4428; A47J 31/4457

(57) ABSTRACT

There is disclosed herein a level detection system includes a housing (120) having a plurality of wall portions defining a receiving space for a container (200). The system further includes a capacitor having a first plate (142a) and a second plate (142b), the wall portions including a first wall portion having the first plate (142a) and a second wall portion having the second plate (142b). When the container is in the receiving space, a capacitance of the capacitor depends on a level of substance in the container (200). The system also includes a processor configured to determine the level of the substance in the container (200) based on the capacitance of the capacitor.

### FIELD

The present invention relates to a level detection system. Preferred embodiments of the present invention relate to detecting a level of a liquid in a container. In one example, the container is a water tank of a coffee machine. In another example, the container is a drip tray of a coffee machine.

The invention has been developed primarily for use with a coffee machine and will be described hereinafter with reference to this application. However, it will be appreciated that the invention is not limited to this particular field of use, and may also be employed in other kitchen appliances or applications involving or requiring the detection of a level of liquid in a container.

### BACKGROUND

An existing system of measuring water level in a water tank or other container of an appliance, such as a coffee machine, uses a floatation component located inside the water tank and a light source or magnet to detect the position of the floatation component in the water tank. The light source system may include an optical (infrared or ultrasonic) sensor, which requires a direct line of sight to the water in the water tank.

Another existing system for measuring water level in a water tank of a coffee machine uses two parallel conductor plates located inside the water tank to provide a measurable capacitance value that is representative of the water level. The capacitive dielectric constant between the plates would depend on the water level in the water tank, which would affect the capacitance value. A change in the water level in the water tank would result in a change in the capacitive dielectric constant.

These existing systems require a sensor component to be located within the water tank. These systems are not suitable for coffee machines or other appliances that have a removable water tank because a component of the sensor system would need to be separable from the rest of the system, which would typically be housed within the main body of the coffee machine or appliance. In addition, the sensor component of these existing systems is in direct contact with the water such that the performance of the level detection would degrade over time depending on the hardness level of the water. In existing systems involving the use of an optical (infrared or ultrasonic) method, the sensors may be subject to splashes or fouling from steam.

### SUMMARY

An object of preferred embodiments of the present invention seeks to address one or more of the problems described above and/or to at least provide the public with a useful choice.

An aspect of the present invention provides a level detection system including: a housing having a plurality of wall portions defining a receiving space for a container: a capacitor having a first plate and a second plate, the wall portions including a first wall portion having the first plate and a second wall portion having the second plate, such that when the container is in the receiving space, a capacitance of the capacitor depends on a level of substance in the container; and a processor configured to determine the level of the substance in the container based on the capacitance of the capacitor.

The level detection system may further include the container. The container is preferably made from a non-conductive material. By way of example, the container may be made from polycarbonate. By way of further example, the container may be made from plastic such as thermoplastic. The container according to preferred embodiments has a cube or cuboid shape defined four side wall portions, and a bottom wall portion.

Preferably, the first and second plates are configured to hug or embrace the container when the container is in the receiving space. The first and second plates may be configured to touch wall portions of the container when the container is in the receiving space. When the container is in the receiving space, there is substantially no air gap between each of the first and the second plates and the container. The receiving space defined by the plurality of wall portions corresponds to a shape of the container.

In a preferred embodiment, the first wall portion having the first plate is substantially non-parallel with respect to the second wall portion having the second plate.

Another aspect of the present invention provides a level detection system including: a housing having a receiving space in which a substance can be contained: a capacitor having a first plate and a second plate, the first plate being substantially non-parallel with respect to the second plate such that a portion of the receiving space is partially bounded by the first and second plates, the capacitor having a capacitance that depends on a level of the substance contained in the receiving space; and a processor configured to determine the level of the substance contained in the receiving space based on the capacitance of the capacitor.

The first plate may be of a first side wall portion defining the receiving space. The second plate may be of a second side wall portion, a bottom wall portion, or a top wall portion defining the receiving space. In a preferred example, the first and second plates are mounted on different side wall portions defining the receiving space. In another example, the first plate is mounted on a side wall portion while the second plate is mounted on a bottom wall portion. In yet another example, the first plate is mounted on a side wall portion while the second plate is mounted on a top wall portion.

The first plate is preferably substantially perpendicular to the second plate. In a preferred embodiment, the first plate and second plate are positioned proximal to a corner of the receiving space.

Each of the first and second plates preferably has a rectangular shape. Each of the first and second plates is substantially flat. In other examples where the container has one of more curved wall portions, the respective one of the first and second plates that is to be positioned against the curved wall portion is also curved.

At least one of the first plate and the second plate has a length that preferably spans a substantial height of the receiving space. In one example, at least one of the first plate and the second plate spans at least 55% of a height of the receiving space. In another example, at least one of the first plate and the second plate spans at least 60% of a height of the receiving space. In yet a further example, at least one of the first plate and the second plate spans at least 70% of a height of the receiving space.

Each of the first plate and the second plate has a width that is preferably about 30% to 60% the length of the respective first plate and second plate. In an example, the width of each of the first and second plates is between about 40% to 50% the length of the respective first and second plates.

Where the first and second plates are positioned on side wall portions of the housing, the first plate and the second plate are preferably each centrally located along a height of the receiving space. Where the second plate is positioned on a bottom or top wall portion of the housing, the second plate is preferably centrally located along a width or depth of the receiving space.

Preferably, the first plate and the second plate are made from a conductive material. By way of example, the first plate and the second plate may be made from aluminium, steel, or copper.

The level detection system preferably further includes a resistor connected in series with the capacitor forming a resistor-capacitor circuit; and a frequency source connected to the resistor to provide an input signal to the resistor-capacitor circuit, wherein the processor is configured to receive an output signal from a point between the resistor and the capacitor in the resistor-capacitor circuit, wherein the liquid level in the container is determined by the processor based on the output signal. In one example, the resistor may have a resistance value of about 100 kΩ, and the frequency source outputs the input signal at a frequency of between about 50 KHz and 80 kHz, preferably at a frequency of 70 KHz. In another example, the resistor has a resistance value of about 47 kΩ and the frequency source outputs the input signal at a frequency of about 200 kHz. In yet a further example the resistor has a resistance value of about 22 kΩ and the frequency source outputs the input signal at a frequency of about 400 KHz.

The level detection system may further include: a look-up table, stored in computer memory in communication with the processor, that correlates different capacitance or voltage values each to a corresponding level value. The processor is preferably configured to determine the level of the substance in the container by: determining at least one of the capacitance of or a voltage across the capacitor; and determining, from the look-up table, the level value that corresponds to the determined capacitance or voltage.

The level detection system preferably further includes one or more reference capacitors for measuring stray capacitance in the receiving space, wherein the processor is configured to determine the level of liquid in the container based on the stray capacitance measured by the reference capacitor(s).

A further aspect of the present invention provides a level detection system including: a housing having a receiving space in which a substance can be contained: a primary capacitor having a first plate and a second plate, a portion of the receiving space being at least partially bounded by the first and second plates, the primary capacitor having a capacitance that depends on a level of the substance contained in the receiving space: one or more reference capacitors for measuring stray capacitance in the receiving space; and a processor configured to determine the level of the substance contained in the receiving area based on the capacitance of the primary capacitor and the stray capacitance measured by the reference capacitor(s).

The one or more reference capacitors may include an upper reference capacitor for measuring stray capacitance in an upper region of the receiving space. Preferably, the upper reference capacitor provides a stray capacitance value for a region of the receiving area in which there is no substance.

The one or more reference capacitors may include a lower reference capacitor for measuring stray capacitance in a lower region of the receiving space. Preferably, the lower reference capacitor provides a stray capacitance value for a region of the receiving area in which there is substance.

In an embodiment, the or each reference capacitor includes: a first reference plate on a first side wall portion of the receiving space: a second reference plate on a second side wall portion of the receiving space; and a third reference plate on a bottom or top wall portion of the receiving space.

Another aspect of the present invention provides a level sensor system for detecting a level of a substance in a receiving space of a housing, the level sensor system including: a capacitor having a first plate and a second plate, the first plate being substantially non-parallel with respect to the second plate, the first plate being locatable on a first wall portion defining the receiving space and the second plate being locatable on a second wall portion defining the receiving space, the capacitor having a capacitance that depends on a level of the substance in the receiving space; and a processor configured to determine the level of the substance in the receiving space based on the capacitance of the capacitor.

The level sensor system preferably further includes one or more reference capacitors for measuring stray capacitance in the receiving space, the processor being configured to determine the level of the substance contained in the receiving area based on the stray capacitance measured by the reference capacitor(s).

Yet a further aspect of the present invention provides a level determining system for determining a level of substance in a receiving space using a level sensor system that includes: a capacitor having a first plate and a second plate such that a portion of the receiving space is at least partially bounded by the first and second plates, the capacitor having a capacitance that depends on a level of the substance in the receiving space, the level determining system including: a look-up table, stored in computer memory, that correlates different capacitance or voltage values each to a corresponding level value: a processor, that is in communication with the computer memory, the processor being configured to determine the level of the substance in the receiving area by: determining at least one of the capacitance of or a voltage across the capacitor; and determining, from the look-up table, the level value that corresponds to the determined capacitance or voltage.

The processor is preferably configured to provide an output when it determines that a level of substance in the receiving space is below a threshold. The output may be any visual output, audio output, or a tactile output.

In a preferred example, the level detection system is for a coffee machine. The container in the preferred example is a water tank for containing water and the level detection system is for detecting a level of water in the water tank. The coffee machine includes a housing that defines a receiving space for the water tank.

### BRIEF DESCRIPTION OF THE DRAWINGS

Preferred embodiments will now be described, by way of non-limiting example, with reference to the accompanying drawings in which:

FIG. 1 shows a rear perspective view of a coffee machine with a level detection system according to an embodiment of the present invention:

FIG. 2 shows a system diagram of the liquid level detection system according to an embodiment of the present invention:

FIG. 3 shows a plot of determined water levels of different samples using a linear classification method according to an embodiment of the present invention:

FIG. 4 shows a plot of average error using the linear classification method:

FIG. 5 shows a conditional probability plot for different sensor output values for a statistical classification method according to an embodiment of the present invention:

FIG. 6 shows a plot of classification accuracy using the statistical classification method:

FIG. 7 shows a plot of determined water levels of different samples using the statistical classification method:

FIG. 8 shows a plot of average error using the statistical classification method:

FIG. 9 shows a schematic perspective view of a coffee machine with a level detection system according to another embodiment:

FIG. 10 shows a schematic front section view of a container of the coffee machine shown in FIG. 9:

FIG. 11 shows a schematic perspective view of a coffee machine with a level detection system according to another embodiment:

FIG. 12 shows a schematic perspective view of a coffee machine with a level detection system according to another embodiment; and

FIG. 13 shows a method or logic system of a level detection system according to one embodiment.

### DESCRIPTION OF EMBODIMENTS

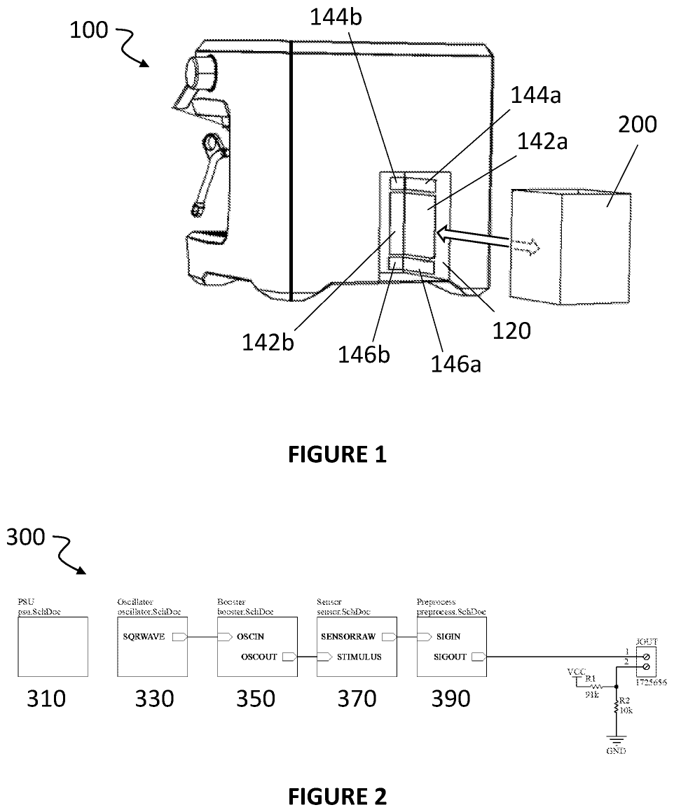

FIG. 1 shows a coffee machine 100 according to an embodiment of the present invention. The coffee machine has a housing 120 defining a receiving space (or a chamber) for a container 200. In this example, the container 200 is a water tank. The container (water tank) 200 stores water that is drawn by a pump of the coffee machine 100 to prepare the coffee. The receiving space is located at a rear of the coffee machine 100. In other examples, the receiving space can be located at a side of the machine, a front of the machine, or a top of the machine.

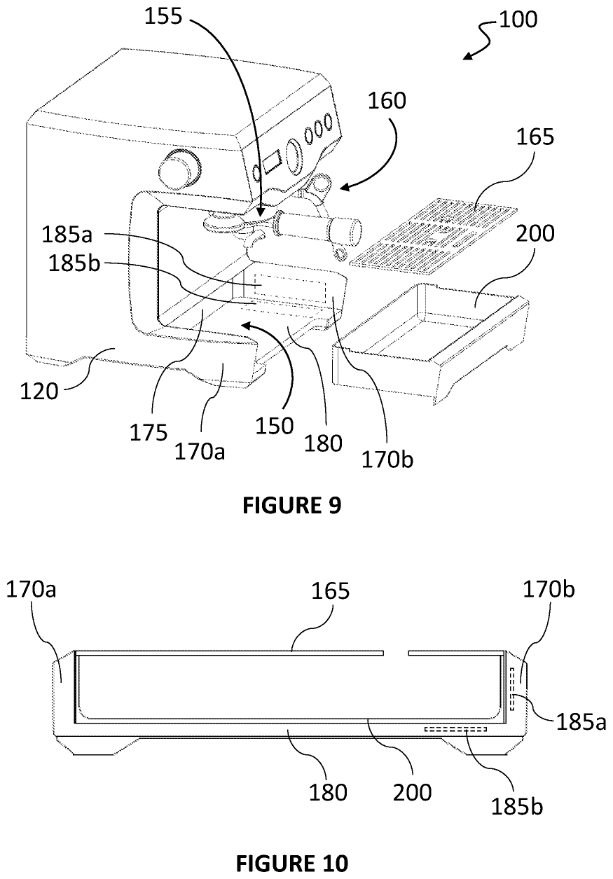

It will be appreciated that in other examples, and with reference to FIGS. 9 to 13, the container 200 may be a drip tray of the coffee machine 100, and the receiving space may be a drip tray recess 150 defined by the housing 120 and located at the bottom of the coffee machine 100. It is envisaged that the present invention is not necessarily limited to a container of a coffee machine, and may be suitable for other types of appliances or machines whereby the detection of a level of substance in a container may be required.

The substance contained by the container in this examples above is water. In other examples, the substance could be any other liquid, a fluid including gas, or solids. The ability of preferred embodiments of the present invention to discriminate different levels of the substance within the container would depend at least in part on the permittivity value of the substance. As will be described in further details below, suitable parameters of the sensor system can be determined to optimise the discrimination ability depending on the substance contained in the container.

The container 200 is made from a non-conductive material such as polycarbonate. By way of further example, the container may be made from other plastics such as a thermoplastic. The container 200 in the embodiment as shown in FIG. 1, has a cube or cuboid shape defined four side wall portions, a bottom wall portion. In other examples, the container may be cylindrical or may be an elongate body having any other cross-sectional area (e.g. a circle cross-sectional area, a triangular cross-sectional area, a pentagon cross-sectional area, a hexagon cross-sectional area, etc). In the embodiment as shown in FIG. 1, an opening is provided in the top of the container (water tank) 200 through which water can be provided into the container 200 and through which a tube can be inserted into the container 200 for drawing water from the container 200. For example, water may be drawn from the container 200 as part of a frothing/streaming operation of the coffee machine steam wand, or as part of the coffee extraction process. Alternatively, in the embodiment of FIGS. 9 to 13, an opening is provided in the top of the container (drip tray) 200 through which water can drip or flow into.

The housing 120 receives the container 200 in its receiving space. In the embodiment as shown in FIG. 1, the receiving space is defined by a plurality of wall portions of the housing 120 with a rear wall of the coffee machine 100 having an opening into the receiving space through which the container (water tank) 200 can be removably located. In this embodiment, the wall portions are internal walls of the coffee machine 100 such that the container 200, when located in the receiving space, is internally located in the coffee machine 100. In other embodiments (not shown), the wall portions may be external walls of the coffee machine. The receiving space is further defined by a bottom wall portion, a top wall portion, two opposite side wall portions, and a rear wall portion of the housing. The bottom wall portion of the housing 120 is a platform or a base on which the container 200 can rest. The receiving space substantially corresponds to a shape of the container 200. The housing may, in an embodiment, provide a snug-fit for the container 200 in the receiving space.

In the embodiment as shown in FIGS. 9 to 13, the receiving space, being the drip tray recess 150, is defined by a plurality of wall portions of the housing 120, and is located below a coffee extraction device (group head) 155 and a frothing/steaming device (steam wand) 160 of the coffee machine 100. In this embodiment, the coffee machine 100 may further include a drip tray cover 165 that is mounted to extend over the opening of drip container (drip tray) 200. The receiving space, being the drip tray recess 150, is defined by a pair of side wall portions 170a. 170b, a rear wall portion 175, and a bottom wall portion 180. In the embodiment as shown in FIG. 9, for example, the pair of side wall portions 170a, 170b, the rear wall portion 175, and the bottom wall portion 180 are external-facing wall portions of the housing 120. It will, however, be understood that the configuration of the wall portions is not necessarily limited to the arrangements as shown in the Figures. The container (drip tray) 200 in the embodiment as shown in FIGS. 9 to 13 is removably received in the drip tray recess 150, and the bottom wall portion 180 is a platform or base on which the container 200 can rest. The receiving space, being the drip tray recess 150, substantially corresponds to a shape of the container (drip tray) 200.

The coffee machine 100 has a control system that is configured to determine whether or not the container 200 is the receiving space. The control system may utilize an output signal from sensors of the level detection system, that will be described in further detail below, or may utilize other sensors (e.g. a pressure sensor or an optical sensor) for determining when the container 200 is or is not in the receiving space (i.e. whether the container 200 is absent or present in the receiving space). When the control system determines that the container 200 is not in the receiving space, the control system is configured to provide an output, on a display device of the coffee machine 100, to insert the container 200 in the receiving space and is configured to disable any coffee-making operations of the machine 100. The output may be any visual output, audio output, or a tactile output. When the control system determines that the container 200 is in the receiving space, the control system is configured to enable coffee-making operations of the machine 100. The control system is a microcontroller having a processor that is in communication with a computer-readable medium or computer memory.

The coffee machine 100 has a level detection system for determining a level of the substance in the container 200, that is—the level of the water in the water tank in the embodiment of FIG. 1, and the level of water or other liquids in the drip tray in the embodiment of FIG. 9. The level detection system is part of the housing 120 and separate from the container 200. The level detection system remains in the coffee machine 100 regardless of whether the container 200 is inserted or removed with respect to the receiving space. Thereby, the integrity of the level detection system would not be compromised by movement of the container 200 with respect to the receiving space. In addition, the level detection system does not contain any sensor that is locatable inside the container 200. The components of the level detection system are externally located with respect to the container 200—the components are not in contact with the substance in the container 200, thereby further preserving the integrity of the level sensor detection system. This is contrast with known level detection systems as earlier described, which undesirably include sensors that are typically in direct contact with water in the container, and which may thus degrade over time the effects (e.g. harness level) of the water, or from splashes or fouling from steam.

The control system of the coffee machine 100 is configured to determine the level of the substance in the container based on an output from the sensors of the level detection system and to display the determined level information on the display device. In the embodiment as shown in FIG. 1, when the level of substance in the container (water tank) 200 is determined by the control system to be below a first threshold, the control system is configured to prompt the user, on the display device of the coffee machine 100, to top up the container with additional substance. When the container 200 is determined by the control system to be below a second threshold, lower than the first threshold, or to be empty, the control system is configured to provide an output, on the display device of the coffee machine 100, to top up the container 200 and is configured to disable any coffee-making operations of the machine. It will be understood that the control system of the coffee machine 100 may be configured to determine any level of the substance within the container 200, including when the container 200 is substantially empty (i.e. when it contains little to no substance). In the embodiment as shown in FIGS. 9 to 12, when the level of substance in the container (drip tray) 200 is determined by the control system to be above one or more thresholds (for example, when the container (drip tray) 200 is nearly full or full), the control system is configured to prompt the user, on the display device of the coffee machine 100, to empty the container (drip tray) 200. The control system may also be configured to disable any coffee-making operations of the machine until the container (drip tray) 200 is emptied. The operation of the control system will be described in further detail below. The output may be any visual output, audio output, or a tactile output.

In the embodiment as shown in FIG. 1, the level detection system includes a capacitor having a first plate 142a and a second plate 142b. When the container 200 is in the receiving space, the plates 142a, 142b face, and are substantially adjacent to, walls of the container. As used herein, this capacitor is later referred to as a ‘primary capacitor’. A portion of the receiving space is at least partially bounded by the first and second plates. The capacitor has a capacitance that depends on a level of the substance contained in the receiving space. In particular, the two plates 142a, 142b of the capacitor are separated by a dielectric medium consisting of wall portions of the container 200 and the substance contained in the receiving space. An amount of substance contained in the receiving space would affect a dielectric permittivity between the plates, thereby affecting the capacitance. Changes in the level of substance in the receiving space would result in changes in the capacitance. The control system is configured to determine the level of the substance contained in the receiving space based on the capacitance of the capacitor.

The first plate and the second plate are made from a conductive material such as aluminium, steel, or copper.

The first plate 142a is substantially non-parallel with respect to the second plate 142b. In particular, the first plate 142a is substantially perpendicular(90°) to the second plate 142b.

In addition, the first plate 142a and second plate 142b are positioned proximal to a corner of the receiving space. That is, the first and second plates are positioned near or adjacent an intersection between two wall portions of the housing 120 that define the receiving space. There is a spacing or gap between the edges of the first and second plates 142a, 142b closest to the corner (or the intersection) to prevent short-circuiting the capacitor.

One of the side wall portions of the housing 120, which defines the receiving space, has the first plate 142a, while the rear wall portion of the housing 120 has the second plate 142b. In other embodiments of the present invention, the second plate 142b may be on a bottom wall portion, or a top wall portion defining the receiving space. According to these other embodiments, the first plate 142a is on a side wall portion while the second plate 142b is on a bottom wall portion or the first plate 142a is on a side wall portion while the second plate 142b is on a top wall portion.

The first and second plates 142a, 142b are configured to hug or embrace the container 200 when the container 200 is in the receiving space. In particular, the first and second plates 142a, 142b touch wall portions of the container 200 when the container 200 is in the receiving space such that there is substantially no air gap between each of the first and the second plates 142a, 142b and the container 200.

Each of the first and second plates 142a, 142b has a flat rectangular shape. Each of the first and second plates is substantially flat. In other examples where the container 200 has one of more curved wall portions, the respective one of the first and second plates 142a, 142b that is to be positioned against the curved wall portion is also curved. It will thus be appreciated that the plates may be shaped or dimensioned to correspond to the shape or dimensions of the container 200.

In a preferred form, the first plate 142a and the second plate 142b each have a length that spans a substantial height of the receiving space. In one example, at least one of the first plate 142a and the second plate 142b spans at least 55% of a height of the receiving space, at least 60% of a height of the receiving space, or at least 70% of a height of the receiving space. Each of the first plate 142a and the second plate 142b has a width that is about 30% to 60% the length of the respective first plate and second plate, preferably between about 40% to 50% the length of the respective plate.

The first plate 142a, which is positioned on the side wall portion of the housing 120 defining the receiving space, has a length of 100 mm and a width of about 100 mm. The second plate 142b, which is positioned on the rear wall portion of the housing 120, has a length of about 100 mm and a width of about 40 mm. Each plate has a thickness of about 1 mm. The container 200 dimensions are about 190 mm in length by about 150 mm in width by about 170 mm in height. According to another example, the container 200 may have any other dimension including any one or more of a length of at least about 300 mm, a width of at least about 60 mm, and a height of at least about 180 mm.

In a preferred form, first plate 142a and the second plate 142b are each centrally located along a height of the receiving space. Where the second plate 142b is positioned on a bottom or top wall portion of the housing 120, the second plate is preferably centrally located along a width or depth of the receiving space.

The level detection system further includes reference capacitors for measuring stray capacitance in the receiving space, wherein the control system is configured to determine the level of liquid in the container 200 based on the stray capacitance measured by the reference capacitor(s). Each reference capacitor includes two plates that are each substantially vertically aligned with a respective plate 142a, 142b of the primary capacitor previously described. Each plate of the reference capacitor faces the same container 200 wall as a respective one of the plates 142a, 142b of the primary capacitor as shown in FIG. 1. In other examples, the plates of each reference capacitor may be offset from the plates of the primary capacitor and/or the or each plate of each reference capacitor may face different container wall than the container walls faced by the plates of the primary capacitor. For example, one plate of the reference capacitor may be provided facing the same side wall as one of the plates of the primary capacitor while the other plate of the reference capacitor is on the top/bottom wall portion of the housing that defines the receiving space. One plate of each reference capacitor is connected to a resistor, which may be the same resistor of the capacitor previously described, while the other plate of the reference capacitor is connected to ground.

The reference capacitors include an upper reference capacitor for measuring stray capacitance in an upper region of the receiving space. The upper reference capacitor includes a first plate 144a and a second plate 144b. The upper reference capacitor provides a stray capacitance measurement for a region of the receiving area in which there is no substance. The upper reference capacitor provides a dry′ reference capacitance for a dry region of the water tank. This dry region of the water tank may be the uppermost portion of the water tank, for example. In the embodiment shown in FIG. 1, the first and second plates 144a, 144b of the upper reference capacitor are positioned on a side wall portion and rear wall portion respectively of the housing that define the receiving space. The first plate 144a has a length of about 100 mm and a width of about 20 mm, while the second plate 144b has a length of about 40 mm and a width of about 20 mm. In other embodiments, one plate of the upper reference capacitor is provided on the side wall portion or the rear wall portion of the housing, while the other plate is provided on the top wall portion of the housing. In these other embodiments, the other plate that is provided on the top wall portion is grounded. The plate that is provided on the top wall portion of the housing has a length of about 100 mm and a width of about 40 mm.

The reference capacitors includes a lower reference capacitor for measuring stray capacitance in a lower region of the receiving space. The lower reference capacitor includes a first plate 146a and a second plate 146b. Preferably, the lower reference capacitor provides a stray capacitance value for a region of the receiving area in which there would normally be substance. The lower reference capacitor provides a ‘wet’ reference capacitance for a wet region of the water tank. In the embodiment shown in FIG. 1, the first and second plates 146a, 146b of the lower reference capacitor are positioned on a side wall portion and rear wall portion respectively of the housing that define the receiving space. The first plate 146a has a length of about 100 mm and a width of about 20 mm, while the second plate 146b has a length of about 40 mm and a width of about 20 mm. In other embodiments, one plate of the upper reference capacitor is provided on the side wall portion or the rear wall portion of the housing, while the other plate is provided on the bottom wall portion of the housing. In these other embodiments, the other plate that is provided on the bottom wall portion is grounded. The plate that is provided on the bottom wall portion of the housing has a length of about 100 mm and a width of about 40 mm.

In the embodiment as shown in FIGS. 9, the level detection system includes a primary capacitor having a first plate 185a and a second plate 185b, which function in a similar manner to the first and second plates 142a, 142b of the embodiment as shown in FIG. 1. In the embodiment as shown in FIG. 9, the first and second plates 185a and 185b are provided on the side wall portion 170b and the bottom wall portion 180, respectively. In this embodiment, the second plate 185b is a ground plate.

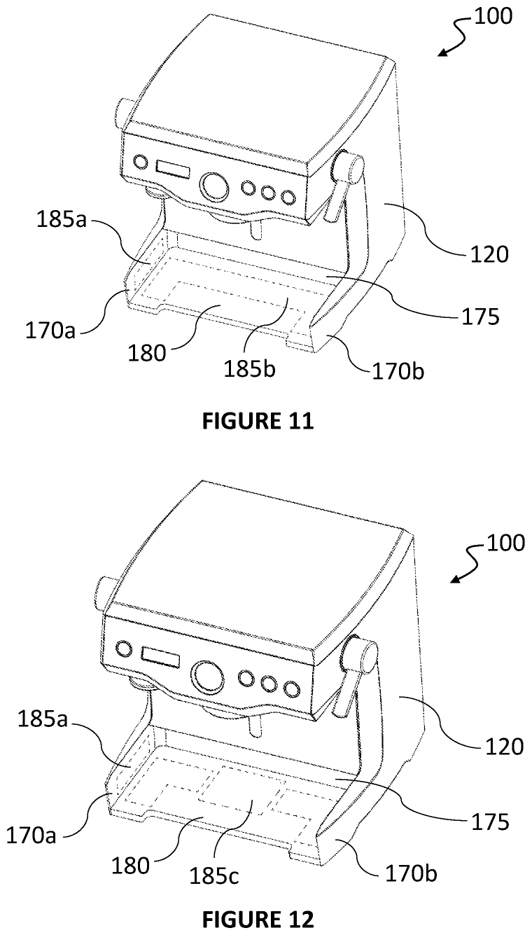

In an alternate arrangement, and as shown in FIG. 11, the first plate 185a is provided on the side wall portion 170a and the second plate 185b is provided on the bottom wall portion 180. This arrangement also includes a third plate (not shown) provided on the side wall portion 170b. In this arrangement, the second plate 185b is a ground plate.

In a further alternate arrangement, and as shown in FIG. 12, the first plate 185a is provided on the side wall portion 170a, the second plate 185b (not shown) is provided on the side wall portion 170b, and a third plate 185c is provided on the bottom wall portion 180. This arrangement also includes a fourth plate 185d and a fifth plate 185e, with one or both of the fourth and fifth plates 185d, 185e being ground plates.

In other embodiments (not shown), any one of the plates 185a, 185b, 185c, 185d, or 185e may be provided on the rear wall portion 175. It will be appreciated that the arrangement and the number of plates provided in the level detection system in the embodiments of FIGS. 1 and 9 to 12 is not limited to the arrangement as shown in the drawings or as described above, and may be customised to suit the design requirements of the level detection system. It will further be appreciate that in embodiments whereby a plate is provided on the rear wall portion 175, for example, the plate may have a greater width relative to its height (i.e. to correspond to the dimensions of the rear wall portion 175), such that the plate may be more sensitive to detect the capacitance of the substance in the container 200 or receiving space.

With reference to FIG. 2, a level detection system 300 according to an embodiment of the present invention for the coffee machine described previously above has:
a power supply 310 to generate dual-rail +/−30 VDC from a 24 VAC transformer;
a frequency source (or an oscillator) 330 to generate an input signal being a 5 Vpp square wave:
a booster 350 to boost the 5 Vpp square wave to a 60 Vpp wave:
the sensor 370 having the conductor plates previously described; and
a peak detector 390 to convert AC signal to DC signal where the DC voltage corresponds to the amplitude of the AC signal.

An input signal from the frequency source (or a voltage oscillator) 330 is boosted by the booster 330. The boosted input signal is provided to the sensor 370, which provides an output signal that is a response to a level of substance in the receiving space and/or container 200. The output signal from the sensor is processed by the peak detector 390. The control system is configured to receive the processed output signal and determine the level of the substance contained in the receiving space and/or container 200 based on that processed output signal.

The sensor 370 includes a resistor connected in series with the capacitor to form a single order RC circuit. The RC circuit is in the form of a low pass filter circuit. One of the capacitor plates is connected to ground while the other capacitor plate is connected to the resistor. In one embodiment, the first plate of the capacitor is connected to ground while the second plate is connected to the resistor. In another embodiment, the first plate of the capacitor is connected to the resistor while the first plate is connected to ground.

The frequency of the input signal of the frequency source 330 and resistance value of the resistor in the sensor 370 are selected to provide the broadest detectable range possible in the output signal for different levels of substance in the container (e.g. from no volume to maximum volume). The dimension and/or shape of the first and second plates of the capacitor, the shape of the container, and the distance between the plates would affect the choice of frequency of the input signal that would provide the broadest detectable range possible in the output signal. The substance type, plate material, and wall material may have some bearing on the choice of resistance value of the resistor and/or the frequency of the input signal.

In the example described with reference to FIG. 1, preferred example combinations of the frequency value of the input signal and the resistance value of the resistor are outlined below.

| | |
|---|---|
| Resistance value | |
| of the resistor | Frequency of the input signal |

| | | |
|---|---|---|
| 22 | kΩ | 200 kHz to 600 kHz (preferably 400 kHz) |
| 47 | kΩ | 100 kHz to 400 kHz (preferably 200 kHz) |
| 100 | kΩ | 40 kHz and 100 kHz (preferably 70/80 kHz) |

Tables 1 to 3 to show the output signal voltages for various combinations of resistance and input signal frequency, from which the preferred example combinations listed above were chosen. For each resistor value, there is an optimal frequency where the range of the capacitor or DC voltage is maximum. The tables below show that the preferred example combinations listed above provide the broadest range in the capacitor voltage.

TABLE 1
Experimental results for 22 and 47 kOhm with various frequencies and water levels.

| | Resistor | | | | | | | |
|---|---|---|---|---|---|---|---|---|
| | 22 kOhm | | | | 47 kOhm | | | |
| | Frequency | | | | | | | |
| | 62 kHz | 100 kHz | 200 kHz | 400 kHz | 62 kHz | 100 kHz | 200 kHz | 400 kHz |
| Capacitor voltage | | | | | | | | |
| (Vpp) at | | | | | | | | |
| 0 cm | 59.2 | 58.8 | 52.4 | 30.6 | 57.6 | 52.4 | 35.4 | 17.2 |
| 5 cm | 59.6 | 58.8 | 50.0 | 27.8 | 56.8 | 50.0 | 32.4 | 15.0 |
| 10 cm | 59.4 | 57.6 | 47.6 | 25.6 | 56.4 | 49.2 | 29.4 | 12.6 |
| 13 cm | 58.8 | 57.6 | 46.8 | 24.0 | 55.2 | 47.4 | 28.0 | 13.0 |
| Range | 0.4 | 1.2 | 5.6 | 6.6 | 2.4 | 5.0 | 7.4 | 4.2 |
| DC voltage | | | | | | | | |
| (V) at | | | | | | | | |
| 0 cm | 28.4 | 28.0 | 25.0 | 14.2 | 27.2 | 25.0 | 16.8 | 7.8 |
| 5 cm | 28.4 | 28.0 | 24.4 | 13.0 | 27.0 | 24.4 | 15.2 | 6.8 |
| 10 cm | 28.4 | 28.0 | 23.2 | 12.2 | 26.8 | 23.2 | 14.0 | 5.4 |
| 13 cm | 28.0 | 27.0 | 22.4 | 11.0 | 26.0 | 22.4 | 13.2 | 5.6 |
| Range | 0.4 | 1.0 | 2.6 | 3.2 | 1.2 | 2.6 | 3.6 | 2.2 |

TABLE 2
Experimental results for 100 kOhm with various frequencies and water levels.

| | Resistor | | | | | | | |
|---|---|---|---|---|---|---|---|---|
| | 100 kOhm | | | | | | | |
| | Frequency | | | | | | | |
| | 31 kHz | 40 kHz | 50 kHz | 62 kHz | 70 kHz | 80 kHz | 100 kHz | 200 kHz |
| Capacitor voltage | | | | | | | | |
| (Vpp) at | | | | | | | | |
| 0 cm | 56 | 56.4 | 52.8 | 47.4 | 46.0 | 42.4 | 34.4 | 18.2 |
| 5 cm | 56 | 52.8 | 48.4 | 44.3 | 40.4 | 37.0 | 31.8 | 16.7 |
| 10 cm | 54.4 | 50.8 | 46.0 | 41.6 | 38.0 | 34.4 | 29.4 | 14.7 |
| 13 cm | 54.4 | 49.6 | 44.8 | 40.2 | 36.8 | 33.2 | 27.9 | 14.2 |
| Range | 1.6 | 6.8 | 8.0 | 7.2 | 9.2 | 9.2 | 6.5 | 4.0 |
| DC voltage | | | | | | | | |
| (V) at | | | | | | | | |
| 0 cm | 26 | 26.0 | 24.8 | 22.6 | 22.0 | 20.0 | 16.4 | 8.4 |
| 5 cm | 26 | 24.8 | 23.2 | 20.4 | 19.2 | 17.6 | 15.0 | 7.3 |
| 10 cm | 25.6 | 23.6 | 22.0 | 19.3 | 18.0 | 16.2 | 13.8 | 6.5 |
| 13 cm | 25.6 | 23.2 | 21.2 | 18.8 | 17.6 | 15.6 | 13.3 | 6.4 |
| Range | 0.4 | 2.8 | 3.6 | 3.8 | 4.4 | 4.4 | 3.1 | 2.0 |

TABLE 3
Experimental results for 220 and 470 kOhm
with various frequencies and water levels.

| | Resistor | | | | | |
|---|---|---|---|---|---|---|
| | 220 kOhm | | | 470 kOhm | | |
| | Frequency | | | | | |
| | 31 kHz | 62 kHz | 100 kHz | 16 kHz | 31 kHz | 62 kHz |
| Capacitor | | | | | | |
| voltage | | | | | | |
| (Vpp) at | | | | | | |
| 0 cm | 44.0 | 28.2 | 18.8 | 39.6 | 26.2 | 14.9 |
| 5 cm | 42.4 | 25.6 | 17.0 | 38.8 | 24.4 | 13.4 |
| 10 cm | 39.8 | 24.0 | 15.4 | 36.3 | 22.5 | 12.2 |
| 13 cm | 38.4 | 23.0 | 14.9 | 35.2 | 21.8 | 11.9 |
| Range | 5.6 | 5.2 | 3.9 | 4.4 | 4.4 | 3.0 |
| DC voltage | | | | | | |
| (V) at | | | | | | |
| 0 cm | 20.4 | 13.0 | 8.8 | 17.4 | 11.8 | 6.5 |
| 5 cm | 19.2 | 11.9 | 7.8 | 17.0 | 11.0 | 5.9 |
| 10 cm | 18.2 | 11.2 | 6.9 | 16.2 | 10.1 | 5.3 |
| 13 cm | 18.0 | 10.6 | 6.6 | 15.8 | 9.6 | 5.1 |
| Range | 2.4 | 2.4 | 2.2 | 1.6 | 2.2 | 1.4 |

The boosted input signal to drive the conductor plates of the sensor is a square wave with an amplitude of 30 V. Typically, a square wave produced by the frequency source 330 of a microcontroller or a timer IC (such as 555 timer) is limited between 5V and 16V. The booster 350 boosts the amplitude of the square wave from the frequency source to the desired amplitude of 30 V. The booster 350 has a series capacitor for removing any DC offset in the input signal from the frequency source 330 to provide a square wave that oscillates from −2.5 V to +2.5 V. That square wave is provided to a switching arrangement that provides the boosted 60 Vpp output signal. In particular, when the square wave When the square wave from the series capacitor is +2.5 V, the switching arrangement switches to provide a +30 V boosted signal. When the square wave from the series capacitor is −2.5 V, the switching arrangement switches to provide a −30 V boosted signal.

The voltage across the conductor plates has the same frequency as the input signal while its amplitude changes in response to the substance level in the receiving space as previously described. The peak detector 390 the AC signal to a DC signal where the output DC voltage is approximately equal to the amplitude of the AC signal. The peak detector circuit provides an output signal between 0 and 5V that can be read by a microcontroller of the control system to determine the substance level.

The microcontroller digitises the DC voltage of the peak detector circuit. The raw samples from the analogue-to-digital converter (ADC) ranges from 0 to 1023 with a 10-bit resolution. The samples are divided by 10 and rounded so that the range is from 0 to 102. The samples are then filtered to remove any large fluctuation noise using either a median or low pass filter. The median filter could for example be 21^{st} order median filter. The low pass filter could be a 1^{st} order IIR low pass filter with coefficient, a=0.8, that is

$$y [ n ] = ( 1 - a ) x [ n ] + a y [ n - 1 ]$$

The low pass filter was found to perform better than the median filter and it did not require sorting the data.

The microcontroller then determines, from the digitised filtered data, the corresponding substance level. The determination can be performed by a linear classification method or by a statistical classification method. The linear classification method assumes a linear relationship between the output signal voltage and the substance level. The statistical classification method, on the other hand, does not assume a linear relationship and instead models the output signal voltage and substance levels as discrete random variables. Their statistics are estimated from a set of training data and the substance level is deduced from the evaluated maximum likelihood from all water levels given a DC voltage from the test data.

These two classification methods will be described in further detail below. For simulation purposes, the DC voltage of the peak detector circuit was sampled at 50 samples per second with respect to water contained in the water tank. For each water level, 3000 samples were collected. The water level in the container ranges from 0 to 13 cm. For the simulation, the resistance value of the resistor of the sensor 370 and frequency of the input signal from the frequency source were set to 100 kOhm and 62 kHz, respectively. Each iteration randomly picks 10% of the data as test data and the remaining 90% as training data, yielding 300 test samples and 2700 training samples. To estimate the average performance, 100 iterations were run.

### Linear Classification

Given the linear model, y=mx+c, the two parameters, m and c, are estimated from a set of training data.

$$m = \frac{{y}_{max} - {y}_{min}}{{x}_{max} - {x}_{min}}$$

$$and$$

$$c = {y}_{min} - m {x}_{min}$$

where yₘₐₓ=13, yₘᵢₙ=0, xₘₐₓ and xₘᵢₙ are the median of the samples at yₘₐₓ and yₘᵢₙ, respectively.

Then, given a set of test data, x, we evaluate the water level, ŷ, and the error level, e=|ŷ−y|.

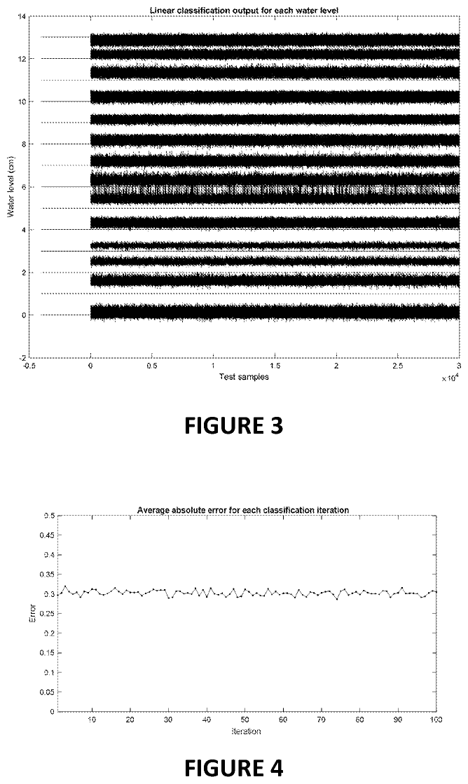

FIG. 3 shows the water level of the test data evaluated using the linear classification across 100 iterations. The results suggest that the calculated levels tend to be slightly higher than the actual level. For some levels, such as the 1 cm level and the 5 cm level, some results are closer to the adjacent level. The error between the evaluated water levels and the actual water levels is calculated as an absolute value of the difference. The average error for each iteration is shown in FIG. 4. The median and std across all iteration is 0.303+/−0.006.

### Statistical Classification

The statistical classification used is the Bayes classifier with maximum likelihood estimation.

For the estimation, X and Y denote the random variables of the filtered data and water level, respectively. Given any x, the conditional probability is evaluated for each possible Y, P(Y|X=x), then the most likely outcome is where the conditional probability is the greatest. The conditional probabilities are calculated using Bayes' theorem.

$$P ( Y \vert X ) = \frac{P ( X , Y )}{P ( X )} = \frac{P ( X \vert Y ) P ( Y )}{P ( X )}$$

where P(X|Y) is the conditional probability of a filtered sample given a water level, P(X) and P(Y) are the marginal probability of X and Y, respectively.

P(X|Y) and P(X) are estimated from a set of training data randomly picked from the filtered data and their associated water level. The training data has 2700 samples for each water level. The conditional probability is then estimated from the histogram of each set of 2700 samples. The marginal probability is estimated from the histogram of the whole sets across all water levels. P(Y) is assumed to be uniform. Given water levels from 0 to 13, P(Y)= 1/14, Given 103 possible values from the ADC and 14 water levels, there are 1442 conditional probability and 117 marginal probability values to store in the microcontroller.

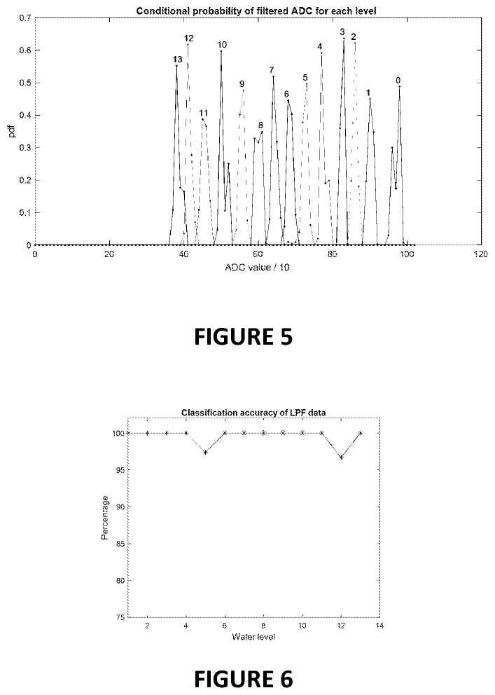

FIG. 5 depicts P(X|Y) from the training samples for each water level. There is minimal overlap between each level due to the use of low pass filter. In each iteration of classification simulation, P(X|Y) and P(X) are calculated from the training data. For each test sample, x, the conditional probability, P(Y|X=x), is calculated for each water level. The water level of x is then

$$f ( x ) = {argmax}_{y ∈ Y} P ( Y = y \vert X = x )$$

This assignment is a ‘hard’ classification. FIG. 6 shows the accuracy of this classification for each water level.

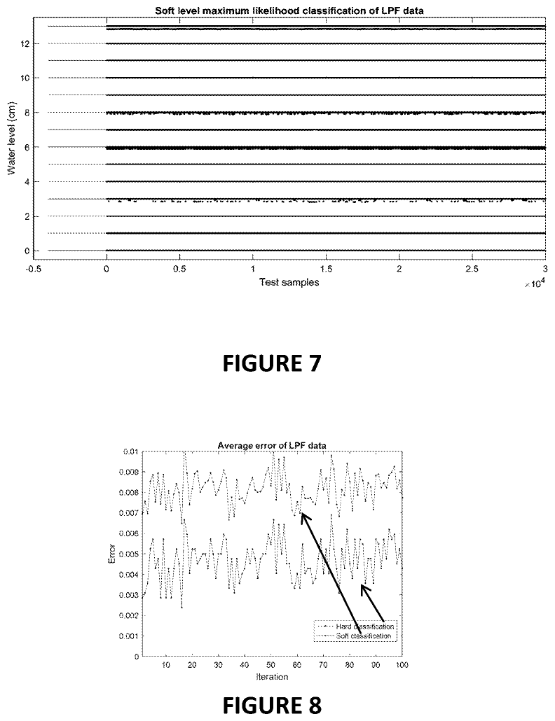

Alternatively, the water level of x can be set to Σᵢ yᵢP(Y=yᵢ|X=x). The resulting water level is then no longer discrete, as depicted in FIG. 7. This assignment is a ‘soft’ classification.

The average absolute error of hard and soft classifications is 0.005±0.001 and 0.008±0.001, respectively, as shown in FIG. 8. The errors in either of the hard and soft classification methods are about 50 times lower compared to the linear classification method previously described.

With respect to the statistical classification method, the level detection system includes: a look-up table, stored in computer memory of the microcontroller. The lookup table stores the conditional probability and marginal probability values previously described. The processor is configured to determine the level of the substance in the container based on the output signal from the sensor and based on the probability values stored in the look-up table.

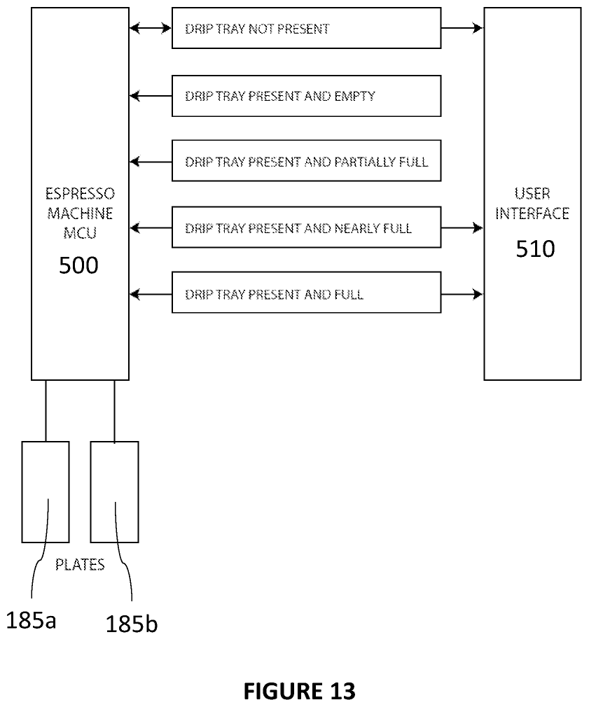

Referring to FIG. 13, a method or logic sequence performed by a control system (microcontroller) 500 of the coffee machine 100 is shown. As described above, the control system 500 of the coffee machine 100 is configured to determine the level of the substance in the container 200 based on an output from the sensors (plates) of the level detection system and to display the determined level information on the user interface (display device) 510.

For the drip tray embodiment as shown in FIGS. 9 to 12, the following method or logic sequence may be followed:
1. Container (drip tray) 200 not present: control system 500 limits or prevents the coffee machine 100 from operating until the container (drip tray) 200 is inserted into the receiving space.
2. Container (drip tray) 200 is present and empty: no indication to user required on the user interface (display device) 510, and the coffee machine 100 operates as normal.
3. Container (drip tray) 200 is present is present and partially full: no indication to user required on the user interface (display device) 510, and the coffee machine 100 operates as normal.
4. Container (drip tray) 200 is present and nearly full: control system 500 displays an indication on the user interface (display device) 510 to the user that the container (drip tray) 200 is nearly full, but allows normal operation of the coffee machine 100 until the container (drip tray) 200 is full.
5. Container (drip tray) 200 is present and full: control system 500 limits or prevents the coffee machine 100 from operating until the container (drip tray) 200 is emptied and re-inserted.

For the water tank embodiment as shown in FIG. 1, the following method or logic sequence (which may be a reverse of the method or logic sequence of the drip tray embodiment described above) may be followed:
1. Container (water tank) 200 is not present: control system 500 limits or prevents the coffee machine 100 from operating until the container (water tank) 200 is inserted and above a minimum fill level or first threshold.
2. Container (water tank) 200 is present but empty: control system 500 limits or prevents the coffee machine 100 from operating until the container (water tank) 200 is filled above a minimum fill level or first threshold.
3. Container (water tank) 200 is present and nearly empty: control system 500 displays an indication on the user interface (display device) 510 to the user that the container (water tank) 200 is nearly empty, but allows normal operation of the coffee machine 100.
4. Container (water tank) 200 is present and full: coffee machine 100 operates as normal.

It will be appreciated that the above arrangement of the drip tray embodiment as shown in FIGS. 9 to 12 may allow for the simplification of the container (drip tray) 200. In typical drip trays, a float located on the floor of the drip tray may used to indicate when the drip tray is full, with the float rising to the surface when this occurs. The float and associated componentry (pivot arm/capture detail) may create an obstacle for users when cleaning the drip tray, as this presents a protrusion near the front wall of the drip tray. By removing the necessity for a float, the inside of the drip tray may be made substantially or entirely smooth and flat, thereby making cleaning a simpler exercise for the user.

The various embodiments of the present invention described above have been presented by way of example only, and not by way of limitation. It will be apparent to a person skilled in the relevant art that various changes in form and detail can be made therein without departing from the spirit and scope of the invention. The present invention should not be limited by any of the exemplary embodiments described above.

1. A level detection system including:
a housing having a plurality of wall portions defining a receiving space for a container:
a capacitor having a first plate and a second plate, the wall portions including a first wall portion having the first plate and a second wall portion having the second plate, such that when the container is in the receiving space, a capacitance of the capacitor depends on a level of substance in the container; and
a processor configured to determine the level of the substance in the container based on the capacitance of the capacitor.

2. The level detection system of claim 1, further including the container.

3. The level detection system of any one of claims 1 to 3, wherein the first and second plates are configured to hug [embrace or touch wall portions of the container] the container when the container is in the receiving space.

4. The level detection system of any one of claims 1 to 3, wherein the first wall portion having the first plate is substantially non-parallel with respect to the second wall portion having the second plate.

5. A level detection system including:
a housing having a receiving space in which a substance can be contained;
a capacitor having a first plate and a second plate, the first plate being substantially non-parallel with respect to the second plate such that a portion of the receiving space is partially bounded by the first and second plates, the capacitor having a capacitance that depends on a level of the substance contained in the receiving space; and
a processor configured to determine the level of the substance contained in the receiving space based on the capacitance of the capacitor.

6. The level detection system of any one of claims 1 to 5, wherein the first plate is of a first side wall portion defining the receiving space.

7. The level detection system of any one of claims 1 to 6, wherein the second plate is of a second side wall portion, a bottom wall portion, or a top wall portion defining the receiving space.

8. The level detection system of any one of claims 1 to 7, wherein the first plate is substantially perpendicular to the second plate.

9. The level detection system of any one of claims 1 to 8, wherein at least one of the first plate and the second plate has a length that spans a substantial height of the receiving space.

10. The level detection system of any one of claims 1 to 8, wherein at least one of the first plate and the second plate has a length spans at least 55% of a height of the receiving space, at least 60% of a height of the receiving space, at least 70% of a height of the receiving space.

11. The level detection system of any one of claims 1 to 10, wherein the first plate and the second plate are each centrally located along a height of the receiving space.

12. The level detection system of any one of claims 1 to 11, wherein the first plate and second plate are positioned proximal to a corner of the receiving space.

13. The level detection system of any one of claims 1 to 12, further including:
a resistor connected in series with the capacitor forming a resistor-capacitor circuit;
a frequency source connected to the resistor to provide an input signal to the resistor-capacitor circuit, wherein the processor is configured to receive an output signal from a point between the resistor and the capacitor in the resistor-capacitor circuit; and
a frequency source connected to the resistor for outputting an input signal across the capacitor through the resistor, wherein the processor is configured to receive an output signal from a point between the resistor and the capacitor, wherein the liquid level in the container is determined by the processor based on the output signal.

14. The level detection system of claim 13, wherein the resistor has a resistance value of about 100 kΩ and the frequency source outputs the input signal at a frequency of between about 50 kHz and 80 KHz.

15. The level detection system of any one of claims 1 to 14, further including:
a look-up table, stored in computer memory in communication with the processor, that correlates different capacitance or voltage values each to a corresponding level value:
wherein the processor is configured to determine the level of the substance in the container by:
determining at least one of the capacitance of or a voltage across the capacitor; and
determining, from the look-up table, the level value that corresponds to the determined capacitance or voltage.

16. The level detection system of any one of claims 1 to 15, further including one or more reference capacitors for measuring stray capacitance in the receiving space, wherein the processor is configured to determine the level of liquid in the container based on the stray capacitance measured by the reference capacitor(s).

17. A level detection system including:
a housing having a receiving space in which a substance can be contained;
a primary capacitor having a first plate and a second plate, a portion of the receiving space being at least partially bounded by the first and second plates, the primary capacitor having a capacitance that depends on a level of the substance contained in the receiving space;
one or more reference capacitors for measuring stray capacitance in the receiving space; and
a processor configured to determine the level of the substance contained in the receiving area based on the capacitance of the primary capacitor and the stray capacitance measured by the reference capacitor(s).

18. The level detection system of claim 16 or 17, wherein the one or more reference capacitors includes an upper reference capacitor for measuring stray capacitance in an upper region of the receiving space.

19. The level detection system of any one of claims 16 to 18, wherein the one or more reference capacitors includes a lower reference capacitor for measuring stray capacitance in a lower region of the receiving space.

20. The level detection system of any one of claims 16 to 19, wherein the or each reference capacitor includes:
a first reference plate on a first side wall portion of the receiving space;
a second reference plate on a second side wall portion of the receiving space; and
a third reference plate on a bottom or top wall portion of the receiving space.

21. A level sensor system for detecting a level of a substance in a receiving space of a housing, the level sensor system including:
a capacitor having a first plate and a second plate, the first plate being substantially non-parallel with respect to the second plate, the first plate being locatable on a first wall portion defining the receiving space and the second plate being locatable on a second wall portion defining the receiving space, the capacitor having a capacitance that depends on a level of the substance in the receiving space; and
a processor configured to determine the level of the substance in the receiving space based on the capacitance of the capacitor.

22. The level sensor system of claim 21, further including one or more reference capacitors for measuring stray capacitance in the receiving space, the processor being configured to determine the level of the substance contained in the receiving area based on the stray capacitance measured by the reference capacitor(s).

23. A level determining system for determining a level of substance in a receiving space using a level sensor system that includes: a capacitor having a first plate and a second plate such that a portion of the receiving space is at least partially bounded by the first and second plates, the capacitor having a capacitance that depends on a level of the substance in the receiving space, the level determining system including:
a look-up table, stored in computer memory, that correlates different capacitance or voltage values each to a corresponding level value;
a processor, that is in communication with the computer memory, the processor being configured to determine the level of the substance in the receiving area by:
determining at least one of the capacitance of or a voltage across the capacitor; and
determining, from the look-up table, the level value that corresponds to the determined capacitance or voltage.
